(19) United States
(12) Patent Application Publication
(10) Pub. No.: US 2010/0169028 A1
(43) Pub. Date: Jul. 1, 2010

(54) PHYSICAL QUANTITY DETECTION CIRCUIT AND PHYSICAL QUANTITY SENSOR DEVICE

(76) Inventors: Yoshinori SHIRAKI, Osaka (JP); Motonori TANIGUCHI, Kyoto (JP)

Correspondence Address: MCDERMOTT WILL & EMERY LLP, 600 13TH STREET, NW, WASHINGTON, DC, 20005-3096, US

(21) Appl. No.: 12/607,572

(22) Filed: Oct. 28, 2009

(30) Foreign Application Priority Data
Dec. 25, 2008 (JP) 2008-331169

(51) Int. Cl. G06F 19/00; G01N 29/00

(52) U.S. Cl. 702/56

(57) ABSTRACT

An analog-to-digital conversion circuit converts a monitor signal and a sensor signal from a physical quantity sensor to a digital monitor signal and a digital sensor signal, respectively. A correction circuit generates a digital correction signal by adjusting the amplitude of the digital monitor signal and the phase difference between the digital monitor signal and the digital sensor signal, and corrects the digital sensor signal using the digital correction signal. A detector circuit detects a physical quantity signal corresponding to the physical quantity given to the physical quantity sensor from the digital sensor signal corrected by the correction circuit.

### CROSS-REFERENCE TO RELATED APPLICATIONS

This application claims priority under 35 U.S.C. §119 on Patent Application No. 2008-331169 filed in Japan on Dec. 25, 2008, the entire contents of which are hereby incorporated by reference.

### BACKGROUND OF THE INVENTION

The technique disclosed herein relates to a physical quantity detection circuit used for a physical quantity sensor that detects a physical quantity given externally and a physical quantity sensor device provided with the same, and more particularly to a technique of correcting a sensor signal outputted from the physical quantity sensor.

Conventionally, physical quantity sensors capable of detecting a physical quantity (e.g., an angular velocity, an acceleration, etc.) are used in a variety of technical fields such as detection of a shake of a digital camera, attitude control of a mobile unit (e.g., an aircraft, an automobile, a vessel, a robot, etc.), guidance of a missile and a spacecraft, and the like.

As an example of such physical quantity sensors, there exists a physical quantity sensor that vibrates self-excitedly with a drive signal while outputting a sensor signal according to a physical quantity given externally. This sensor signal includes, not only a physical quantity signal corresponding to the physical quantity given to the physical quantity sensor, but also noise (a noise signal synchronizing with the drive signal) superimposed thereon. Therefore, in order to improve the detection precision of the physical quantity, it is important to attenuate the noise in the sensor signal.

Japanese Laid-Open Patent Publication No. 2005-233811 discloses a physical quantity detection circuit provided with a correction circuit for correcting a sensor signal. This correction circuit, constructed of a plurality of resistances and switches, steadily removes a predetermined signal component (noise signal component) from the sensor signal.

### SUMMARY OF THE INVENTION

However, since the conventional correction circuit is constructed of analog circuits, the amplitude and phase of a signal component removed from the sensor signal fluctuate with fluctuations in power supply voltage and changes in temperature. For this reason, the predetermined signal component fails to be removed accurately from the sensor signal, and resultantly noise is left unremoved. Hence, accurate correction of the sensor signal is conventionally difficult.

An object of the technique disclosed herein is to provide a physical quantity detection circuit in which degradation in noise correction precision caused by fluctuations in power supply voltage and changes in temperature can be suppressed.

According to one aspect of the present invention, the physical quantity detection circuit is a physical quantity detection circuit used for a physical quantity sensor that vibrates from self-excitation by application of a drive signal to output a monitor signal responsive to the self-excited vibration and also outputs a sensor signal according to a physical quantity given externally. The circuit includes: an analog-to-digital conversion circuit configured to convert the monitor signal and the sensor signal to a digital monitor signal and a digital sensor signal, respectively; a correction circuit configured to generate a digital correction signal by adjusting the amplitude of the digital monitor signal and the phase difference between the digital monitor signal and the digital sensor signal and correct the digital sensor signal using the digital correction signal; and a detector circuit configured to detect a physical quantity signal corresponding to the physical quantity from the digital sensor signal corrected by the correction circuit. In this physical quantity detection circuit, with the correction circuit being digitized, fluctuations in the adjustment amounts in the correction circuit, which occur with fluctuations in power supply voltage and changes in temperature, can be suppressed. This permits accurate setting of the amplitude of the digital correction signal and the phase difference between the digital correction signal and the digital sensor signal. Hence, the digital sensor signal can be corrected accurately.

Preferably, the analog-to-digital conversion circuit described above selectively executes first analog-to-digital conversion processing of converting the monitor signal to the digital monitor signal and second analog-to-digital conversion processing of converting the sensor signal to the digital sensor signal. With this digitization of the monitor signal and the sensor signal with the common analog-to-digital conversion circuit, it is possible to reduce the differences in amplitude and phase between the digital monitor signal and the digital sensor signal. Hence, the correction precision of the digital sensor signal can be further improved.

Preferably, the correction circuit described above interpolates digital values of the digital correction signals. With this configuration, a shift in data between the digital sensor signal and the digital correction signal, caused by the lag in sampling timing between the monitor signal and the sensor signal, can be reduced. Hence, the correction precision of the digital sensor signal can be further improved.

Preferably, the analog-to-digital conversion circuit described above switches between the first analog-to-digital conversion processing and the second analog-to-digital conversion processing in synchronization with a control clock that is based on the drive signal as the frequency reference, and the detector circuit detects the physical quantity signal from the digital sensor signal corrected by the correction circuit using a detection signal that is based on the drive signal as the frequency reference. With this configuration, the digital sensor signal and the detection signal can be synchronized with each other. Hence, the detection precision of the physical quantity can be improved.

### BRIEF DESCRIPTION OF THE DRAWINGS

FIG. 1 is a view showing an example configuration of a physical quantity sensor device of Embodiment 1.

FIG. 2 is a view showing an example configuration of a physical quantity detection circuit shown in FIG. 1.

FIGS. 3A to 3D are views illustrating processing by a correction circuit shown in FIG. 2.

FIG. 4 is a view illustrating generation of a digital detection signal by a digital detection signal generator shown in FIG. 2.

FIG. 5 is a view showing an example configuration of a physical quantity sensor device of Embodiment 2.

FIG. 6 is a view showing an example configuration of a physical quantity detection circuit shown in FIG. 5.

FIG. 7 is a view illustrating time division processing by the physical quantity detection circuit of FIG. 6.

FIG. 8 is a view showing an alteration of the physical quantity detection circuit of FIG. 6.

FIG. 9 is a view illustrating digital interpolation processing by the physical quantity detection circuit of FIG. 8.

FIG. 10 is a view showing an alteration of a detector circuit.

### DESCRIPTION OF THE PREFERRED EMBODIMENTS

Hereinafter, preferred embodiments will be described in detail with reference to the accompanying drawings. It should be noted that identical or equivalent components are denoted by the same reference characters throughout the drawings, and description thereof will not be repeated.

### Embodiment 1

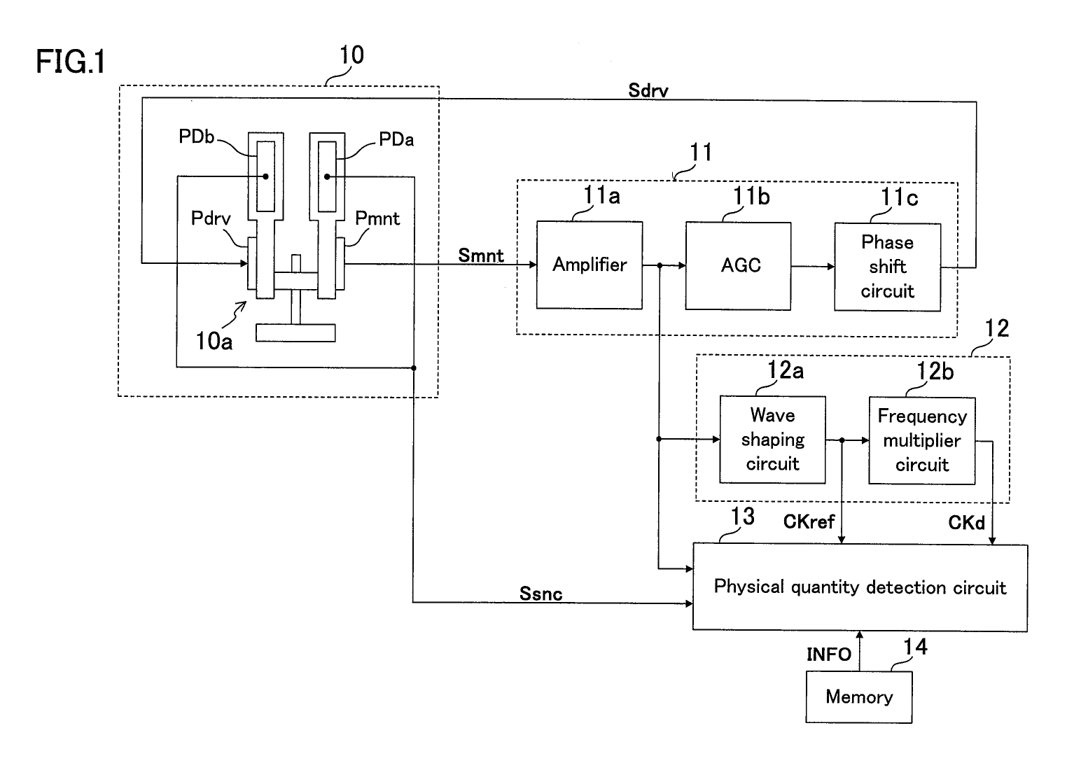

FIG. 1 shows an example of the configuration of a physical quantity sensor device of Embodiment 1. This physical quantity sensor device includes a physical quantity sensor 10, a drive circuit 11, a clock generation circuit 12, a physical quantity detection circuit 13, and a memory 14.

[Physical Quantity Sensor]

The physical quantity sensor 10 vibrates from self-excitation by application of a drive signal Sdrv having a predetermined frequency, and outputs a monitor signal Smnt responsive to the self-excited vibration. Also, the physical quantity sensor 10 outputs a sensor signal Ssnc according to a physical quantity (e.g., an angular velocity, an acceleration, etc.) given externally. In this embodiment, the physical quantity sensor 10 is described as a tuning fork type angular velocity sensor. The physical quantity sensor 10 includes, for example, a tuning fork body 10a, a drive piezoelectric element Pdrv, a monitor piezoelectric element Pmnt, and sensor piezoelectric elements PDa and PDb. The tuning fork body 10a has two prongs each twisted by the right angle in the center, a connection for connecting the two prongs at their ends on one side, and a support pin provided at the connection to serve as a rotation axis. The drive piezoelectric element Pdrv vibrates one prong according to the drive signal Sdrv supplied from the drive circuit 11, and this causes resonance of the two prongs. With this vibration of the tuning fork, charge is generated in the monitor piezoelectric element Pmnt (i.e., the monitor signal Smnt is generated). Also, when a rotational angular velocity (Coriolis force) is generated, an amount of charge responsive to the rotational angular velocity is generated in the sensor piezoelectric elements PDa and PDb (i.e., the sensor signal Ssnc is generated).

[Drive Circuit]

The drive circuit 11 supplies the drive signal Sdrv to the physical quantity sensor 10. Also, the drive circuit 11 controls the drive signal Sdrv according to the monitor signal Smnt from the physical quantity sensor 10. The drive circuit 11 includes, for example, an amplifier 11a, an automatic gain control amplifier (AGC) 11b, and a phase shift circuit 11c. The amplifier 11a converts the monitor signal Smnt from the physical quantity sensor 10 to a voltage. The AGC 11b amplifiers or attenuates the monitor signal Smnt from the amplifier 11a and outputs the resultant signal as the drive signal Sdrv. Also, the AGC 11b changes its amplification gain according to the amplitude of the monitor signal Smnt so that the amplitude of the drive signal Sdrv be kept constant. For example, as the amplitude of the monitor signal Smnt is greater, the amplification gain of the AGC 11b is made smaller. The phase shift circuit 11c adjusts the phase of the drive signal Sdrv so as to match with the phase of the monitor signal Smnt. With this control of the drive signal Sdrv according to the monitor signal Smnt, the maximum amplitude and frequency of the vibration of the physical quantity sensor 10 can be kept constant.

[Clock Generation Circuit]

The clock generation circuit 12 generates a reference clock CKref and a detection clock CKd based on the monitor signal Smnt, and includes, for example, a wave shaping circuit 12a and a frequency multiplier circuit 12b. The wave shaping circuit 12a converts the drive signal Sdrv to a square wave and outputs the resultant signal as the reference clock CKref. The wave shaping circuit 12a is constructed of a comparator or an inverter, for example. The frequency multiplier circuit 12b multiplies the reference clock CKref from the wave shaping circuit 12a and outputs the resultant clock as the detection clock CKd. The frequency multiplier circuit 12b is constructed of a phase locked loop (PLL), for example.

[Physical Quantity Detection Circuit]

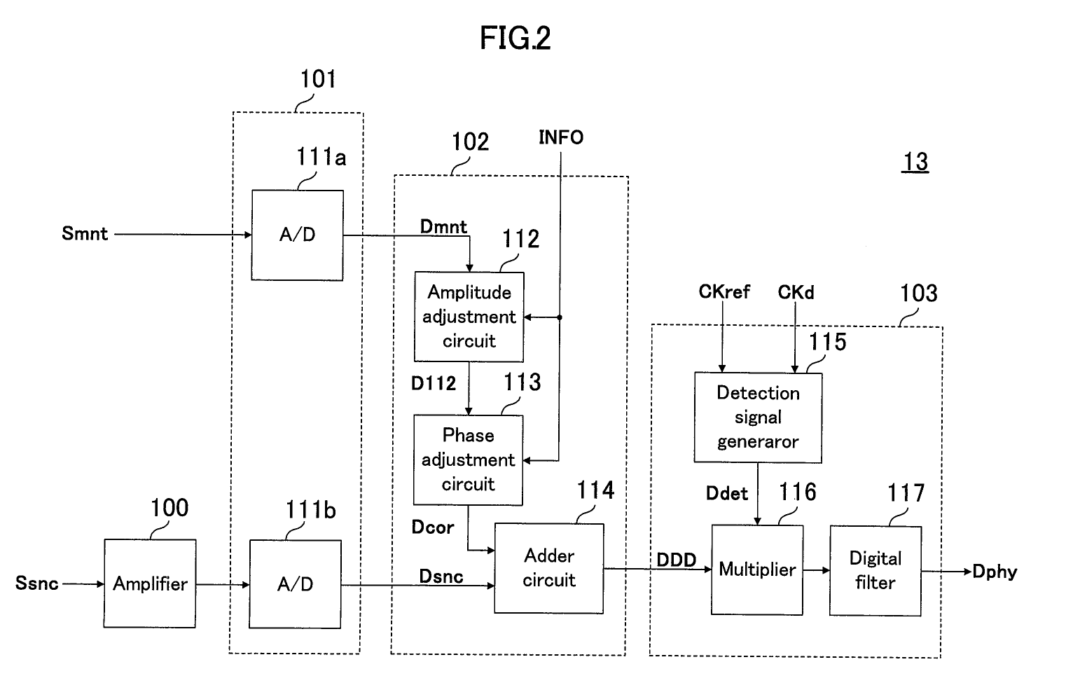

FIG. 2 shows an example configuration of the physical quantity detection circuit 13 shown in FIG. 1. The physical quantity detection circuit 13 executes noise correction of the sensor signal, detection of a physical quantity signal, and the like. The physical quantity detection circuit 13 includes, for example, an amplifier 100 for converting the sensor signal Ssnc from the physical quantity sensor 10 to a voltage, an analog-to-digital conversion circuit 101, a correction circuit 102, and a detector circuit 103.

The analog-to-digital conversion circuit 101 includes an analog-to-digital converter 111a that converts the monitor signal Smnt to a digital monitor signal Dmnt, and an analog-to-digital converter 111b that converts the sensor signal Ssnc from the amplifier 100 to a digital sensor signal Dsnc.

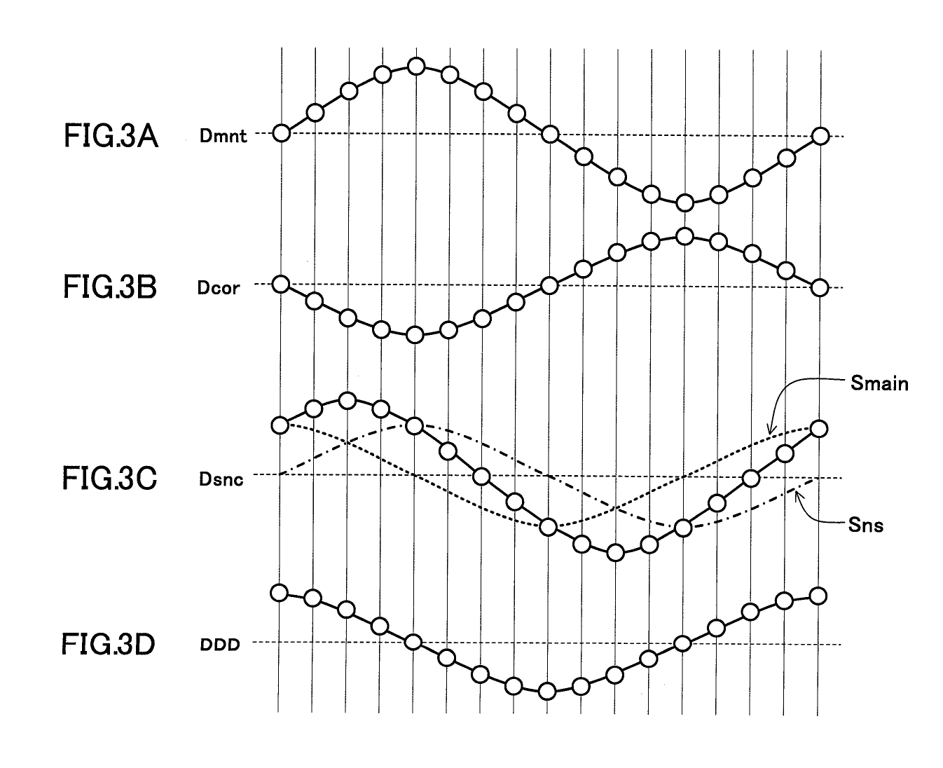

The correction circuit 102 adjusts the amplitude of the digital monitor signal Dmnt based on correction information INFO stored in the memory 14, and also adjusts the phase difference between the digital monitor signal Dmnt and the digital sensor signal Dsnc, to generate a digital correction signal Dcor for attenuating noise in the digital sensor signa1 Dsnc. The correction information INFO includes an amplitude adjustment amount and a phase adjustment amount. Also, the correction circuit 102 corrects the digital sensor signal Dsnc using the digital correction signal Dcor. The correction circuit 102 includes, for example, an amplitude adjustment circuit 112, a phase adjustment circuit 113, and an adder circuit 114. The amplitude adjustment circuit 112 corrects the amplitude of the digital monitor signal Dmnt (FIG. 3A) based on the correction information INFO (amplitude adjustment amount) from the memory 14 and outputs the resultant signal as a digital correction signal D112. The amplitude adjustment circuit 112 is constructed of a multiplier that multiplies the digital monitor signal Dmnt by the amplitude adjustment amount, for example. The phase adjustment circuit 113 corrects the phase of the digital correction signal D112 based on the correction information INFO (phase adjustment amount) so that the phase difference between the digital correction signal D112 and a noise signal Sns included in the digital sensor signal Dsnc be 180°, and outputs the resultant signal as the digital correction signal Dcor (FIG. 3B). The phase adjustment circuit 113 is constructed of a shift register that sequentially shifts the digital correction signal D112, and a selector that selects any one of outputs at the stages of the shift register based on the phase adjustment amount and outputs the selected one, for example. The adder circuit 114 adds the digital correction signal Dcor to the digital sensor signal Dsnc (FIG. 3C), and outputs the added result as a digital sensor signal DDD (FIG. 3D).

As shown in FIG. 3C, the digital sensor signal Dsnc corresponds to a combined signal of a main-component signal Smain whose phase leads that of the drive signal Sdrv by 90° and the noise signal Sns synchronizing with the drive signal Sdrv. The main-component signal Smain includes a physical quantity signal corresponding to the physical quantity given to the physical quantity sensor 10 superimposed thereon. In other words, the main-component signal Smain (several tens of kHz, for example) has been amplitude-modulated with the physical quantity signal (several Hz, for example). As shown in FIG. 3B, the digital correction signal Dcor corresponds to an inverted signal of the noise signal Sns. By adding the digital correction signal Dcor to the digital sensor signal Dsnc, the noise of the digital sensor signal Dsnc (noise signal Sns) is attenuated, and as a result, the digital sensor signal DDD corresponding to the main-component signal Smain is obtained.

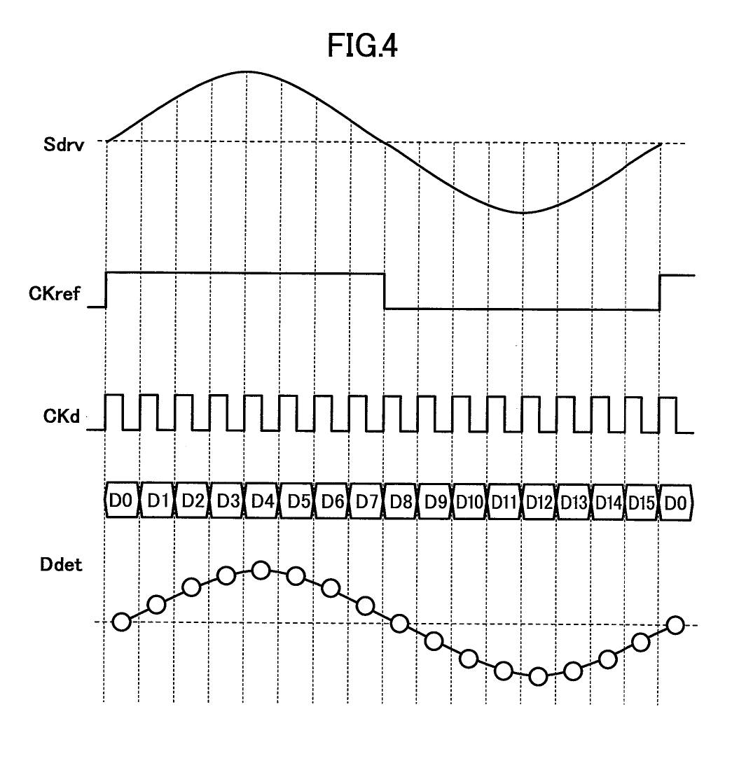

The detector circuit 103 detects the physical quantity signal from the digital sensor signal DDD obtained by the correction circuit 102. The detector circuit 103 includes, for example, a detection signal generator 115, a multiplier 116, and a digital filter 117. The detection signal generator 115, operating in synchronization with the detection clock CKd, starts generation of a digital detection signal Ddet in response to a transition edge of the reference clock CKref. The digital detection signal Ddet contains a plurality of digital amplitude values. For example, as shown in FIG. 4, a plurality of digital amplitude values D0, D1, D2, . . . correspond to a plurality of analog amplitude values obtained by sampling a sine wave signal having a predetermined frequency (e.g., the drive signal Sdrv) in synchronization with a predetermined clock (e.g., the detection clock CKd). The plurality of digital amplitude values D0, D1, D2, . . . may otherwise be ideal amplitude values expressed by a sine function. That is, the detection signal generator 115 outputs the digital amplitude values D0, D1, D2, . . . sequentially in synchronization with the detection clock CKd, thereby generating the digital detection signal Ddet. The multiplier 116 multiplies the digital sensor signal DDD from the correction circuit 102 by the digital detection signal Ddet, thereby detecting a digital physical quantity signal. The digital filter 117 attenuates the high-frequency component of the digital physical quantity signal obtained by the multiplier 116, while allowing the low-frequency component thereof to pass therethrough as a digital physical quantity signal Dphy.

As described above, by digitizing the correction circuit 102, fluctuations in the adjustment amounts (the amplitude adjustment amount and the phase adjustment amount) in the correction circuit 102, which occur with fluctuations in power supply voltage and changes in temperature, can be suppressed. Therefore, the amplitude value of the digital correction signal Dcor and also the phase difference between the digital correction signal Dcor and the digital sensor signal Dsnc can be set accurately, and hence the digital sensor signal Dsnc can be corrected accurately. In this way, the detection precision of the physical quantity can be improved.

The placement of the amplitude adjustment circuit 112 and the phase adjustment circuit 113 is not limited to that in FIG. 2. For example, the phase adjustment circuit 113 may be placed upstream of the amplitude adjustment circuit 112. In other words, the amplitude of the digital monitor signal Dmnt may be adjusted after the phase thereof has been adjusted. Otherwise, the phase adjustment circuit 113 may be placed between the analog-to-digital converter 111b and the adder circuit 114, to adjust the phase of the digital sensor signal Dsnc so that the phase difference between the digital correction signal Dcor and the noise signal Sns included in the digital sensor signal Dsns be 180°.

[Amplitude Adjustment Amount and Phase Adjustment Amount]

The correction information INFO (the amplitude adjustment amount and the phase adjustment amount) may be settable arbitrarily. For example, the correction information INFO may be written in the memory 14 by a digital signal processing circuit (e.g., a digital signal processor (DSP)) connected downstream of the physical quantity detection circuit 13. When no physical quantity is given to the physical quantity sensor 10, the physical quantity detection circuit 13 will detect the noise component Sns included in the sensor signal Ssnc as the digital physical quantity signal Dphy. Using this, the digital signal processing circuit may calculate an ideal digital correction signal based on the digital physical quantity signal Dphy that has been detected when no physical quantity is given to the physical quantity sensor 10, and calculate the amplitude adjustment amount and the phase adjustment amount based on the differences in amplitude and phase between the ideal digital correction signal and the digital monitor signal Dmnt. Also, the phase adjustment amount may be calculated considering a delay caused by the processing of the monitor signal Smnt and the sensor signal Ssnc (e.g., a delay in the amplitude adjustment circuit 112 and a delay in the amplifier 100), to thereby permit further accurate setting of the phase of the digital correction signal Dcor.

### Embodiment 2

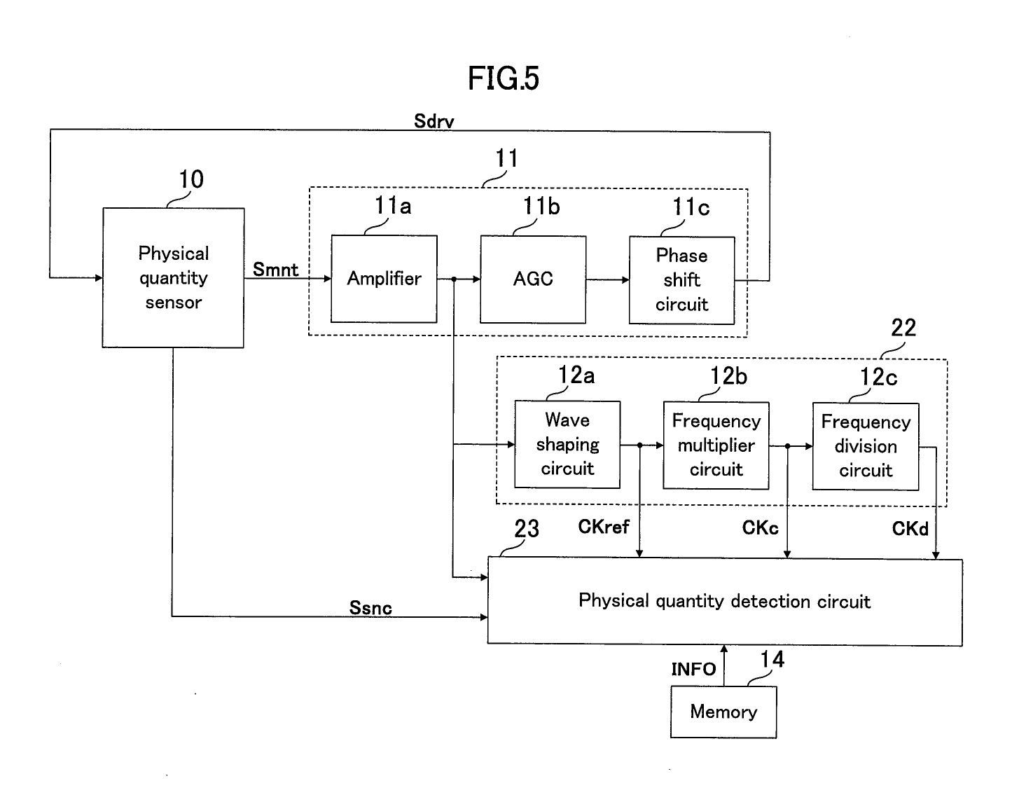

FIG. 5 shows an example configuration of a physical quantity sensor device of Embodiment 2. This physical quantity sensor device includes a clock generation circuit 22 and a physical quantity detection circuit 23 in place of the clock generation circuit 12 and the physical quantity detection circuit 13 shown in FIG. 1. The other configuration is similar to that of FIG. 1. The clock generation circuit 22 includes the wave shaping circuit 12a and the frequency multiplier circuit 12b shown in FIG. 1 and a frequency division circuit 12c. The frequency multiplier circuit 12b multiplies the reference clock CKref to generate a control clock CKc, and the frequency division circuit 12c divides the frequency of the control clock CKc to generate the detection clock CKd. The frequency of the control clock CKc is preferably at least twice as high as the frequency of the detection clock CKd.

[Physical Quantity Detection Circuit]

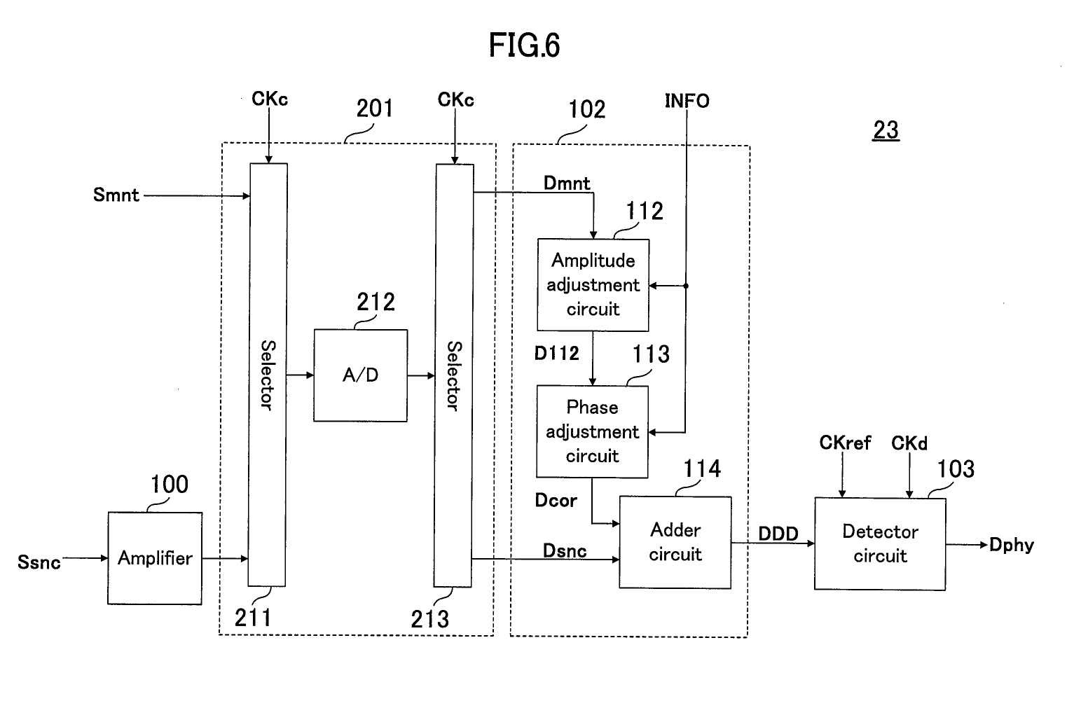

FIG. 6 shows an example configuration of the physical quantity detection circuit 23 shown in FIG. 5. The physical quantity detection circuit 23 includes an analog-to-digital conversion circuit 201 in place of the analog-to-digital conversion circuit 101 shown in FIG. 2. The other configuration is similar to that of FIG. 2.

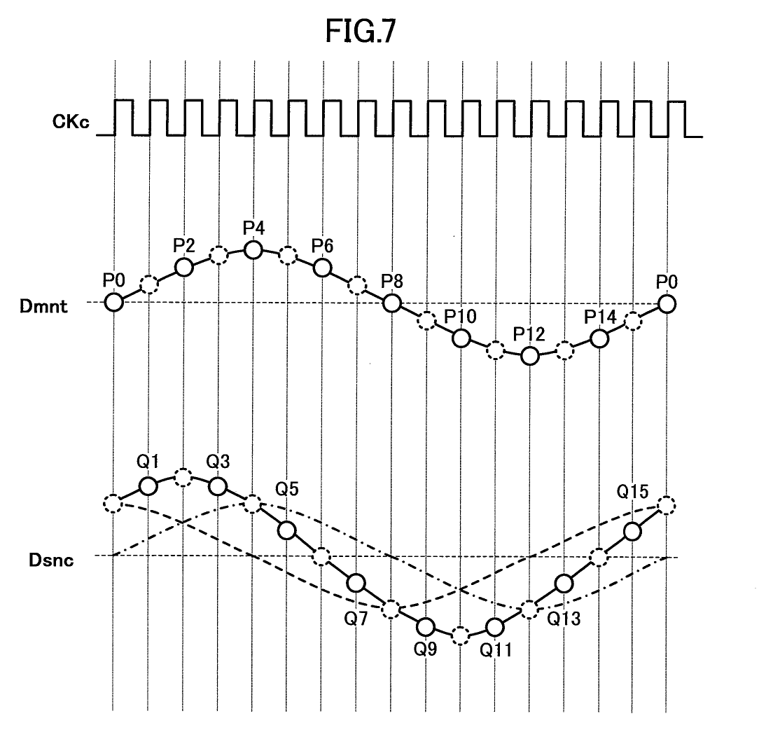

The analog-to-digital conversion circuit 201 selectively executes analog-to-digital conversion processing for the monitor signal Smnt and that for the sensor signal Ssnc. The analog-to-digital conversion circuit 201 includes, for example, a selector 211, an analog-to-digital converter 212, and a selector 213. The selector 211 selects the monitor signal Smnt and the sensor signal Ssnc alternately in synchronization with the control clock CKc. The analog-to-digital converter 212 converts the signal selected by the selector 211 to a digital signal. The selector 213, operating in synchronization with the control clock CKc, supplies the digital signal from the analog-to-digital converter 212 to the amplitude adjustment circuit 112 as the digital monitor signal Dmnt when the selector 211 is selecting the monitor signal Smnt, and to the adder circuit 114 as the digital sensor signal Dsnc when the selector 211 is selecting the sensor signal Ssnc. For example, as shown in FIG. 7, digital values P0, P2, P4, . . . constituting the digital monitor signal Dmnt and digital values Q1, Q3, Q5, . . . constituting the digital sensor signal Dsnc are alternately generated in synchronization with the control clock CKc. In this way, the monitor signal Smnt and the sensor signal Ssnc are digitized in the time division manner.

As described above, by digitizing the monitor signal Smnt and the sensor signal Ssnc with the common analog-to-digital converter, the differences in amplitude and phase between the digital monitor signal Dmnt and the digital sensor signal Dsnc can be reduced, and as a result, the correction precision of the digital sensor signal Dsnc can be further improved.

Also, by synchronizing the respective operation clocks (the control clock CKc and the detection clock CKd) for the selectors 211 and 213 and the detection signal generator 115 with each other, the digital sensor signal DDD and the digital detection signal Ddet can be synchronized with each other, and this can improve the precision of the detection. Note that the selectors 211 and 213 may otherwise be operated in synchronization with an operation clock asynchronous to the detection clock CKd (e.g., a clock supplied externally).

(Alteration of Embodiment 2)

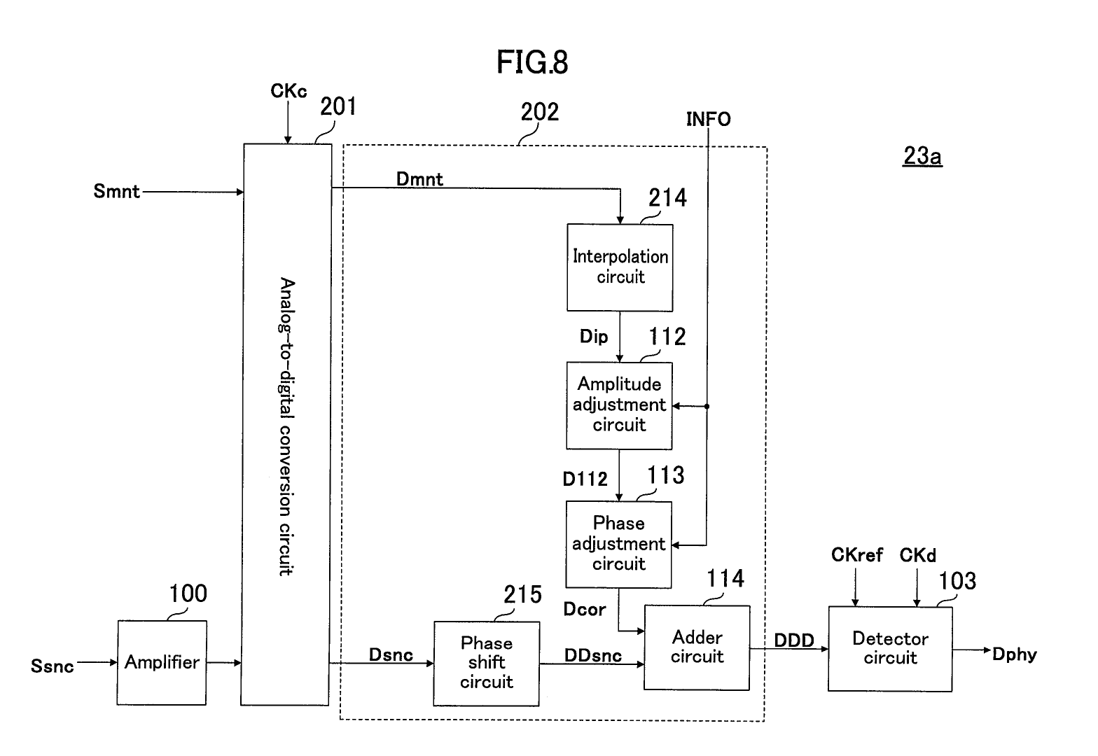

As shown in FIG. 8, the physical quantity detection circuit may have the function of interpolating digital values of the digital correction signal Dcor. A physical quantity detection circuit 23a of FIG. 8 includes a correction circuit 202 in place of the correction circuit 102 shown in FIG. 6. The correction circuit 202 includes an interpolation circuit 214 that interpolates digital values of the digital monitor signal Dmnt and a phase shift circuit 215 that adjusts the phase of the digital sensor signal Dsnc, in addition to the components of the correction circuit 102 shown in FIG. 6. The phase shift circuit 215 is constructed of a shift register that sequentially shifts the digital sensor signal Dsnc, for example.

In the selective execution of the analog-to-digital conversion processing of the monitor signal Snmt and that of the sensor signal Ssnc, the sampling timing of the monitor signal Smnt does not synchronize with the sampling timing of the sensor signal Ssnc. Therefore, as shown in FIG. 7, the digital values P0, P2, P4, . . . constituting the digital monitor signal Dmnt do not correspond to the digital values Q1, Q3, Q5, . . . constituting the digital sensor signal Dsnc.

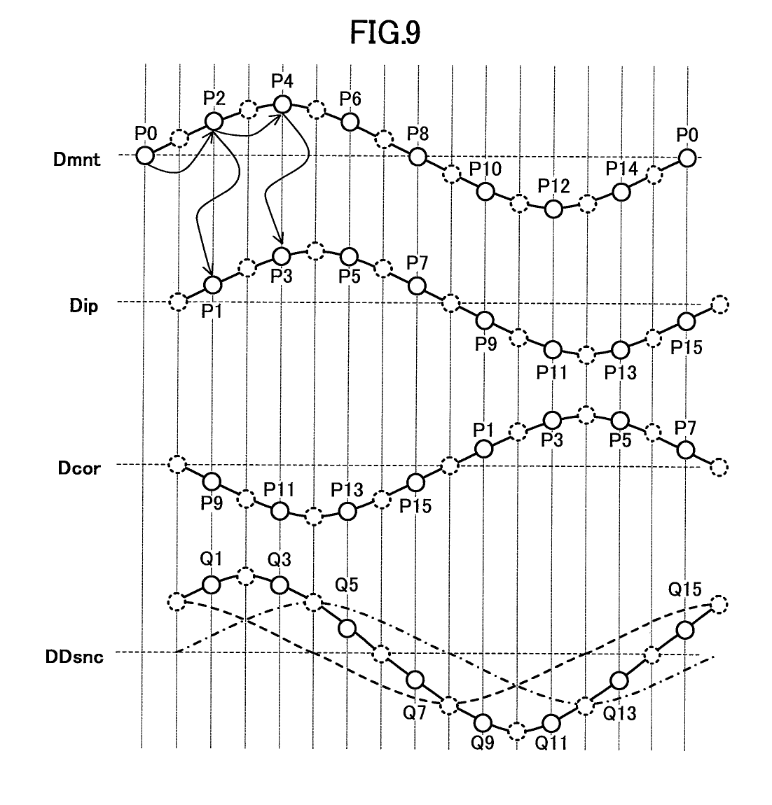

In this alteration, as shown in FIG. 9, the interpolation circuit 214 generates digital values P1, P3, P5, . . . respectively corresponding to the digital values Q1, Q3, Q5, . . . based on the digital values P0, P2, P4, . . . . For example, the interpolation circuit 214 calculates the average value of the two adjacent digital values P0 and P2 as the digital value P1. In this way, a digital interpolation signal Dip corresponding to the digital sensor signal Dsnc is generated. The amplitude adjustment circuit 112 and the phase adjustment circuit 113 respectively adjust the amplitude and phase of the digital interpolation signal Dip, to generate the digital correction signal Dcor. Hence, by interpolating digital values of the digital monitor signal Dmnt, digital values of the digital correction signal Dcor are interpolated.

The phase shift circuit 215 adjusts the phase of the digital sensor signal Dsnc so as to match with the phase of the digital interpolation signal Dip, and outputs the resultant signal as a digital sensor signal DDsnc.

As described above, by interpolating digital values of the digital correction signal Dcor, it is possible to reduce a shift in data between the digital sensor signal Dsnc and the digital correction signal Dcor, which originates from the lag in sampling timing between the monitor signal Smnt and the sensor signal Ssnc. Hence, the correction precision of the digital sensor signal Dsnc can be further improved.

The placement of the amplitude adjustment circuit 112, the phase adjustment circuit 113, the interpolation circuit 214, and the phase shift circuit 215 is not limited to that in FIG. 8. For example, the interpolation circuit 214 may be placed downstream of the amplitude adjustment circuit 112 or the phase adjustment circuit 113. That is, interpolation of digital values may be executed after the adjustment of the amplitude and/or phase of the digital monitor signal Dmnt. Also, the phase shift circuit 215, not the phase adjustment circuit 113, may be used for the setting so that the phase difference between the digital correction signal Dcor and the noise signal Sns included in the digital sensor signal DDsnc be 180°. In other words, the phase shift circuit 215 may be provided with the phase adjustment function.

### Other Embodiments

In the above embodiments, the analog-to-digital converters 111a, 111b, and 212 may be operated in synchronization with an operation clock that is based on the drive signal Sdrv as the frequency reference (e.g., a clock obtained by multiplying the reference clock CKref). With this configuration, the sampling timing of the sensor signal Ssnc can be synchronized with the detection clock CKd. This can eliminates a shift in data between the digital sensor signal DDD and the digital detection signal Ddet, and hence the precision of the detection can be further improved. Note that the analog-to-digital converters 111a, 111b, and 212 may otherwise be operated in synchronization with an operation clock that is not based on the drive signal Sdrv as the frequency reference (e.g., a clock supplied externally).

The physical quantity detection circuits 13, 23, and 23a may further include a phase adjustment circuit for adjusting the phase of the digital detection signal Ddet. In this case, by setting the phase adjustment amount of the digital detection signal Ddet according to the phase adjustment amount of the digital correction signal Dcor, the detection precision can be further improved.

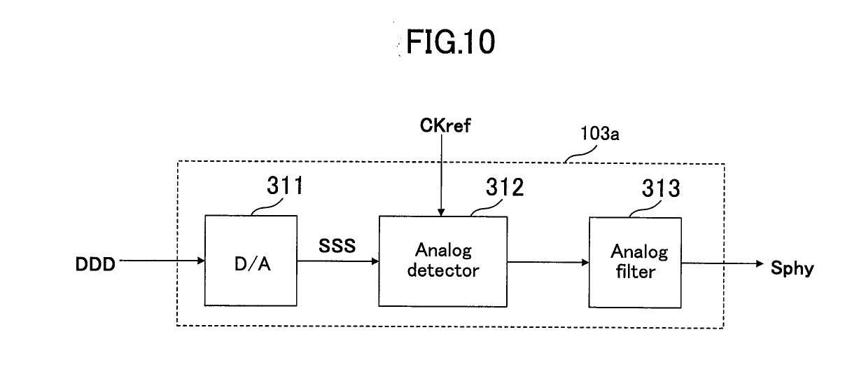

The physical quantity detection circuits 13, 23, and 23a may be configured to detect the physical quantity signal corresponding to the physical quantity given to the physical quantity sensor 10 as an analog signal. For example, the physical quantity detection circuits 13, 23, and 23a may include a detector circuit 103a as shown in FIG. 10 in place of the detector circuit 103. The detector circuit 103a includes: a digital-to-analog converter 311 that converts the digital sensor signal DDD to an analog sensor signal SSS; an analog detector 312 that synchronously detects an analog physical quantity signal from the analog sensor signal SSS with the reference clock CKref; and an analog filter 313 that attenuates the high-frequency component of the analog physical quantity signal detected by the analog detector 312, while allowing the low-frequency component thereof to pass therethrough as an analog physical quantity signal Sphy.

The physical quantity sensor 10 does not have to be of the tuning fork type, but may be of a circular cylinder type, a regular triangular prism type, a square prism type, or a ring type, or may be of another shape.

As described above, the physical quantity detection circuit described above, with which the detection precision of the physical quantity can be improved, is suitable for physical quantity sensors used in mobile units, cellular phones, digital cameras, game machines, and the like.

It should be noted that the embodiments described above are essentially preferred illustrations, and by no means intended to restrict the scope of the present invention, applications thereof, or uses thereof.

What is claimed is:

1. A physical quantity detection circuit used for a physical quantity sensor that vibrates from self-excitation by application of a drive signal to output a monitor signal responsive to the self-excited vibration and also outputs a sensor signal according to a physical quantity given externally, the circuit comprising:
an analog-to-digital conversion circuit configured to convert the monitor signal and the sensor signal to a digital monitor signal and a digital sensor signal, respectively;
a correction circuit configured to generate a digital correction signal by adjusting the amplitude of the digital monitor signal and the phase difference between the digital monitor signal and the digital sensor signal and correct the digital sensor signal using the digital correction signal; and
a detector circuit configured to detect a physical quantity signal corresponding to the physical quantity from the digital sensor signal corrected by the correction circuit.

2. The physical quantity detection circuit of claim 1, wherein the analog-to-digital conversion circuit selectively executes first analog-to-digital conversion processing of converting the monitor signal to the digital monitor signal and second analog-to-digital conversion processing of converting the sensor signal to the digital sensor signal.

3. The physical quantity detection circuit of claim 2, wherein the correction circuit interpolates digital values of the digital correction signals.

4. The physical quantity detection circuit of claim 2, wherein the analog-to-digital conversion circuit switches between the first analog-to-digital conversion processing and the second analog-to-digital conversion processing in synchronization with a control clock that is based on the drive signal as the frequency reference, and
the detector circuit detects the physical quantity signal from the digital sensor signal corrected by the correction circuit using a detection signal that is based on the drive signal as the frequency reference.

5. The physical quantity detection circuit of claim 1, wherein the analog-to-digital conversion circuit includes:
a first analog-to-digital converter configured to convert the monitor signal to the digital monitor signal; and
a second analog-to-digital converter configured to convert the sensor signal to the digital sensor signal.

6. The physical quantity detection circuit of claim 1, wherein the detector circuit includes:
a detection signal generator configured to generate a digital detection signal in synchronization with a detection clock that is based on the drive signal as the frequency reference; and
a multiplier configured to multiply the digital sensor signal corrected by the correction circuit by the digital detection signal generated by the detection signal generator to thereby detect the physical quantity signal.

7. The physical quantity detection circuit of claim 4, wherein the detector circuit includes:
a detection signal generator configured to generate a digital detection signal in synchronization with a detection clock that is based on the drive signal as the frequency reference; and
a multiplier configured to multiply the digital sensor signal corrected by the correction circuit by the digital detection signal generated by the detection signal generator to thereby detect the physical quantity signal, and
the frequency of the control clock is at least twice as high as the frequency of the detection clock.

8. The physical quantity detection circuit of claim 1, wherein the detector circuit includes:
a digital-to-analog converter configured to convert the digital sensor signal corrected by the correction circuit to an analog sensor signal; and
an analog detector configured to synchronously detect the physical quantity signal from the analog sensor signal obtained by the digital-to-analog converter with an analog detection signal that is based on the drive signal as the frequency reference.

9. A physical quantity sensor device comprising:
a physical quantity sensor configured to vibrate from self-excitation by application of a drive signal to output a monitor signal responsive to the self-excited vibration, and also output a sensor signal according to a physical quantity given externally;
a drive circuit configured to control the drive signal based on the monitor signal from the physical quantity sensor; and
the physical quantity detection circuit of claim 1.
